(19) United States
(12) Patent Application Publication
(10) Pub. No.: US 2006/0092771 A1
(43) Pub. Date: May 4, 2006

(54) Automated method and system for creating an image storage device for playback on a playback mechanism

(75) Inventors: Alexander C. Loui, Penfield, NY (US); Frank Marino, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/977,570

(22) Filed: Oct. 29, 2004

(51) Int. Cl. G11B 21/08

(52) U.S. Cl. 369/30.01

(57) ABSTRACT

An automated method for creating an image storage device such as a disk, and more particularly a DVD, CD, or CD-ROM for playback on a playback mechanism entails initiating a device with a processor. A user is instructed to connect a digital image capture device to the device, wherein digital records with image content and metadata are downloaded from the digital device into the processor's memory. Metadata extracted from the image metadata is sorted into groups based upon set parameters. The groups are mapped into a digital file template forming a digital file with chapters, wherein each group corresponds to a chapter. A bit stream representing the chapters is a sequential order is created from the digital file. The bit stream is saved to memory, sent to a writer, and written to a DVD, CD or CD-ROM. The written DVD, CD or CD-ROM is provided to the user.

### FIELD OF THE INVENTION

The present embodiments relate to automated methods and systems for creating an image storage device such as a disk, and more particularly a DVD, compact disk (CD) or CD-ROM for playback on a playback mechanism.

### BACKGROUND OF THE INVENTION

Photographs, videos, and memorabilia collections are very commonly used to maintain memories and events that formed a part of a person's life. These collections serve to augment the human memory and enrich the process of sharing stories related to the memories. When organized, viewed and shared on a regular basis a collection of memory artifacts generates a large reward, enriching the lives of all involved. The nature of these collections is such that they grow steadily, event by event, year by year, and soon become large and difficult to manage. Collections of photos and memorabilia are considered one of the most important and valued possessions by most people. These collections possess intrinsic, emotional value, even if they are never viewed, because the need to preserve a memory of life is strong and universal. Since these memories have relative importance to the persons involved, the prior art is replete with teachings that disclose organizational methods.

Although the presently known and utilized methods for partitioning images are satisfactory, there are drawbacks. The manual classification is obviously time consuming, and the automated process, although theoretically classifying the images into events, is susceptible to miss-classification due to the inherent inaccuracies involved with classification by only image characteristics, such as color, shape or texture.

Consequently, a need exists for a method to easily organize and store images on an image storage device such as a DVD or CD. The present embodiments meet these needs.

### SUMMARY OF THE INVENTION

An automated method for creating an image storage device such as a DVD or CD for playback on a playback mechanism entails initiating a processor that includes memory, an input port connected to the memory, an output port connected to the memory, an interactive input device connected to the processor, and a display connected to the processor. The processor is connected to the interactive input device. The method continues by providing a first instruction onto the display requesting a user to operationally associate a digital image capture device to the input port and then providing a second instruction via the input port to the digital image capture device requesting a download of digital records to the processor. The digital records comprise image metadata and image content. The digital records can contain video content and video metadata. Next, numerous digital records are downloaded into the memory and associated metadata are extracted from the image metadata in the memory. The associated metadata includes date, time, location, people, and other information related to the image content.

After extracting the associated metadata, an optional third instruction is provided to the display requesting parameters to sort the digital records based on the image metadata and image content. The parameters are received and used to sort the digital records via the interactive input device to memory. In a fully automated embodiment, parameters, such as more or less grouping, is not requested because the algorithm can group or cluster the collection of images into separate event groups using a default setting. Based on the parameter input and the automated algorithms, the digital records are sorted to form groups of digital records. The groups of digital records are mapped into a digital file template forming a digital file with chapters. Each group corresponds to a chapter. Next, a bit stream is created from the digital file with chapters. The bit stream represents the chapters is a sequential order. The method ends by saving the bit stream to the memory and writing the bit stream to an output port connected to the DVD or CD writer, thereby forming a written DVD or CD. The written DVD or CD is then provided to the user.

The present embodiments are advantageous over the prior art because the methods provide a fully automated and easy way to author a DVD or CD with minimum user interactions. The fully automated and easy manner described herein enables the system to produce DVDs or CDs for TV viewing of images in a highly efficient manner. The prior art has not integrated such automated image grouping capability into a DVD or CD authoring application or system.

### BRIEF DESCRIPTION OF THE DRAWINGS

In the detailed description of the preferred embodiments presented below, reference is made to the accompanying drawings, in which:

FIG. 1 depicts a flow chart of the embodiment for an automated method for creating a CD or DVD for playback on a playback mechanism.

FIG. 2 depicts a device usable in the method.

FIG. 3 depicts a flow chart of an embodied method for an automated manner for organizing digital records on a processor.

FIG. 4 depicts an alternative embodiment of a device usable with the method.

FIG. 5 depicts the device used in the embodied methods as self-serving kiosk.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The benefits of the method are to allow users easily and quickly to turn digital media into an image storage device such as a disk, and more particularly a DVD, CD or CD-ROM that can be viewed with any DVD or CD player. The methods allow the user to create a DVD or CD and send pictures or other digital media to another person that does not have a computer, but has a DVD or CD player. The digital media can then be viewed as a video slide show. In the past, creating a DVD or CD like the one created by this method requires a personal computer and a very knowledgeable computer user to create a finished DVD or CD product. The methods embodied herein overcome the problems associated with manual classifications that can be time consuming. The embodied method can be an automated process that classifies the images into events.

One method to group images effectively is to utilize an image and the associated captured metadata. Typically, the metadata is obtained from a digital camera, camera phone, or other similar device. The methods, thereby, provide a more accurate grouping of images into temporal events as compared to methods that utilize only image characteristics, such as color, shape, or texture. In particular, event groups can be determined automatically using algorithms that analyze captured date and time, as well as the color histogram of images. Event boundaries can be determined by applying a 2-means clustering algorithm to the time difference histogram associated with the input images. For each event detected, sub-event boundaries can be determined using a block histogram correlation method. These block histogram correlation methods have been disclosed in prior art, for example U.S. Pat. No. 6,351,556, and U.S. Pat. No. 6,606,411. Other methods of detecting event and sub-event clusters can be used in place of the above techniques. For example, other event clusters can be formed by grouping images that contain a particular person, images that were taken in the same location or place, or images that have similar content. By utilizing automated event grouping algorithm in the process of authoring a DVD or CD, user images can be more efficiently and effectively grouped together for better content organization and viewing experience. The automated image event grouping algorithm eliminates the time consuming process of ordering and organizing the set of images for DVD or CD authoring.

An automated method for creating a DVD or CD for playback on a playback mechanism entails initiating a processor. The processor typically includes memory, an input port connected to the memory, an output port connected to the memory, an interactive input device connected to the processor, and a display connected to the processor and the interactive input device. A first instruction is displayed requesting a user to operationally associate a digital image capture device to the input port. A second instruction is sent to the digital image capture device via the input port requesting digital records to be downloaded to the processor. The digital records include image content and associated metadata. The associated metadata, such as date, time, location, are extracted from the downloaded digital records.

An optional third instruction can be displayed requesting the user to enter parameters for sorting. The parameters are used to indicate to the sorting algorithm the preference for grouping, such as by date/time, by people, or by location/place. The default is to use the date/time metadata for event grouping. The digital records are then sorted using an event grouping algorithm.

Based on the results of the event grouping algorithm, the digital records are sorted into groups of digital records. The groups are mapped into a digital file template. The digital file template is used to form a digital file with chapters. Each group of digital records corresponds to a chapter. The method continues by creating a bit stream from the digital file with chapters. The bit stream represents the chapters in a sequential order. The bit stream is saved to the memory and typically sent to an output port connected to the DVD or CD writer. A written DVD or CD is formed and provided to the user.

In a second embodiment, the methods are customizable automated manners for creating a DVD or CD for playback on a playback mechanism. The customization comes from more interaction with the user. The method utilizes a processor. A first instruction is displayed requesting a user to operationally associate a digital image capture device to the input port. A second instruction is sent to the digital image capture device via the input port requesting a download of digital records to the processor. The digital records include image content and associated metadata. The digital records are stored into the memory. The associated metadata, such as date, time, and location, are extracted from the digital records.

After extracting the associated metadata from the image metadata, an optional third instruction can be displayed requesting parameters from the user to be used to sort the digital records, such as allowing the user to specify more or less groupings and the type of grouping desired. The parameters are received via the interactive input device and used to sort the digital records to be saved to the memory. Digital records are sorted based using event grouping algorithms with optional input parameters to form groups of digital records.

The customized method allows a more interactive manner of creating a DVD or CD. After the images are automatically sorted, typically using the event grouping algorithm, the user can review and edit the resulted groupings, if necessary, to make appropriate changes to the groupings using the interactive input device. The reviewed and edited groups of digital records are then mapped to a digital file template, thereby forming a digital file with chapters. A customized digital file with chapters can then be created by selecting a theme for at least a portion of the DVD or CD based upon a theme list stored previously in the memory. Music for the DVD or CD can be selected for at least a portion of the DVD or CD based upon a music list stored previously in the memory. The user can input a title using the user interface. The customized decisions are added to the memory to create a customized digital file with chapters. A new, first bit stream is created from the customized digital file with chapters. A second bit stream is created from the first bit stream, wherein the second bit stream represents the chapters in a sequential order. The second bit stream is saved to memory and then sent to the output port connected to a DVD or CD writer to form a written DVD or CD. The user is then provided with the customized written DVD or CD.

In a third embodiment, the methods are automated manners for organizing digital records on a processor. The method utilizes a processor, wherein a digital record capture device is instructed to download digital record content and associated metadata via an input port. The downloaded digital record content and associated metadata is saved to memory. The associated metadata, such as date, time, and location, is extracted from the digital records metadata and stored to memory.

The digital records are sorted using image event grouping algorithms based on the optional input parameters and the extracted metadata. The parameters can include a user's choice for type of organization, such as sorting by event, by people, by location, or combination thereof. The parameters are typically input or selected by a user using the interactive input device to form groups of digital records. The method can be automated by using event grouping algorithms. An index file of the groups of digital records is created, wherein the index file represents an event boundary of the various groups. The digital record metadata with the event boundaries information are used to create updated digital records. The updated digital records and the index file are saved to the memory and, then written to a disk and provided to the user.

The various methods can entail an additional step of placing a preprinted label onto the written DVD, CD or disk after the bit stream is written to the DVD, CD or disk. A custom label can be made for the written DVD, CD or disk by entering text through the interactive input device and instructing the processor to provide a printing instruction to a printer connected to the processor to print the text on the custom label.

Another additional step that can be used with the embodied methods entails adding an automatic transition between the groups of digital records and/or adding an automatic transition between digital images within a group. Examples of automatic transitions usable between the groups of images or individual images include “fade in”, “dissolve”, “fade out”, “zoom in”, “zoom out”, “split screen”, and other similar transitions. Furthermore, the length and types of transition between each group of digital records and the transition between the digital images within a group can be different depending on the content of the digital records.

The embodied methods can include an additional step, wherein additional instructions are provided to the user to indicate a quantity of DVDs, CDs or disks to be produced. The indicated quantity is then used to produce the quantity of DVDs, CDs or disks indicated by the user.

The various embodiments can have an additional step of instructing the user to input additional text via the interactive input device and instructing the user to input additional digital content via the input port. The additional text and/or digital content can be saved to the memory prior to creating the bit stream. For example, the user can insert additional text for chapter titles or other digital content to be utilized as background for title menus. Furthermore, other additional steps can be added in order to identifying each chapter by a chapter number after mapping is complete. The groups can be sorted into subgroups based upon the image metadata and image content.

The embodied methods can be integrated into a self-service kiosk, wherein a user can bring a digital device and operationally associate the digital device to an input port through, for example, a physical connection or a wireless communication. The digital content from the digital device is downloaded into the device, wherein the user follows instructions to create a DVD or CD from the downloaded digital content.

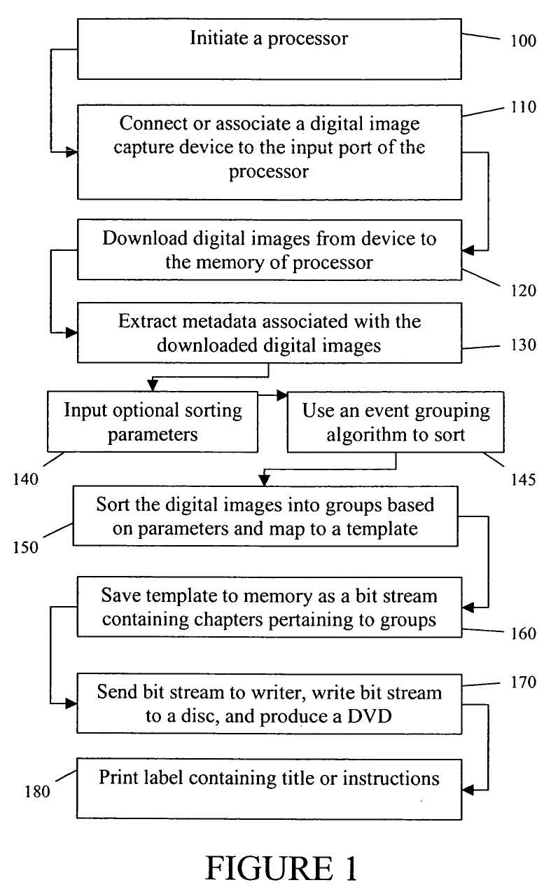

With reference to the figures, FIG. 1 depicts a flow chart of the embodiment for an automated method for creating an image storage device such as a DVD, CD or disk for playback on a playback mechanism. The method begins by initiating a processor (Step 100).

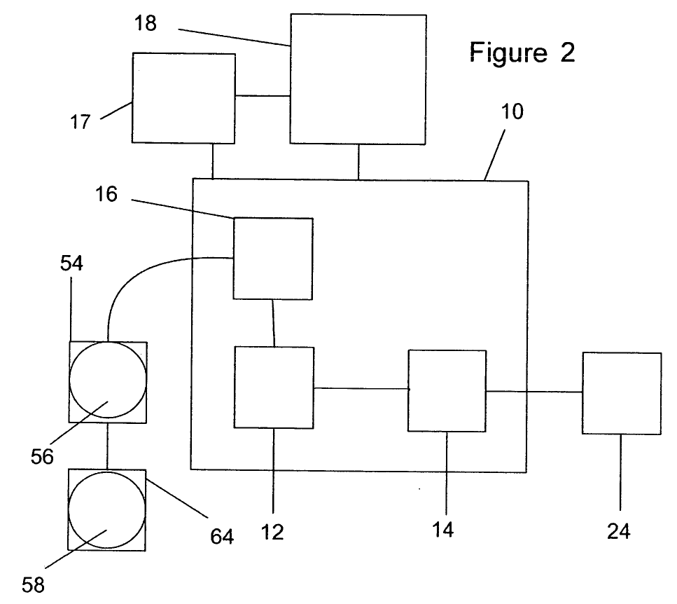

FIG. 2 depicts a device usable in the method. The device has a processor 10. The processor 10 includes memory 12, an input port 14 connected to the memory 12, an output port 16 connected to the memory 12, an interactive input device 17 connected to the processor 10, and a display 18 connected to the processor 10 and the interactive input device 17. Examples of interactive input devices 17 include a touch screen display, a mouse, a keyboard, or a wand. The processor 10 and display 18 can be a kiosk or a self-service, stand-alone type kiosk. That is, in a preferred implementation of the invention, a user creates a DVD or CD at a stand-alone and/or self-service type kiosk. The processor 10 is connected to a DVD and/or a CD writer 54 via the output port 16 that forms written DVD and/or CD 56 from the created bit stream. The user can input text on the interactive input device 17. The text is sent to a printer 64 to create a label 58 that can be affixed to the written DVD and/or CD 56.

Returning to FIG. 1, the user is sent a first instruction via the display 18, wherein the user is asked to operationally associate a digital device 24 to the input port 14 (Step 110) by way of a physical connection or a wireless communication via a wireless enabled interface. Examples of digital image capture devices 24 include camera phone, a digital camera, a digital camcorder, a compact disc, a CD-ROM, a disk, a hard disk, an internet, a lap top, a PDA, a wireless device, or combinations of these.

The digital records stored in the digital device 24 are downloaded and, typically, stored to memory 12 (Step 120). The associated metadata is extracted from the digital records (Step 130). Examples of metadata include a date, a time, a location, a content description, a subject, a person, or combinations of these. An optional instruction, typically via the display 18, is then sent to the user to input parameters used to sort the records to form groups (Step 140). Based on the input parameters an appropriate event grouping algorithm is used for sorting (Step 145). After the groups are formed, the groups are mapped to the template to create a digital file with chapters corresponding to the groups (Step 150). The template is encoded into a bit stream that is saved to memory 12 (Step 160). The bit stream is written to a DVD and/or CD writer 54, produced, and provided to the user (Step 170). The method can entail the optional step of printing a label with instructions or a title and affixing the label to the created DVD and/or CD 56 (Step 180).

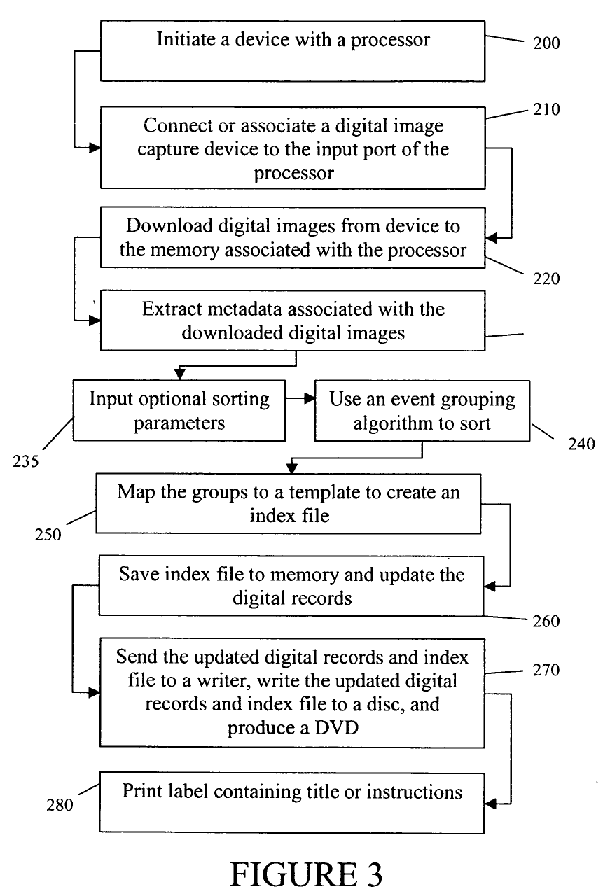

FIG. 3 depicts a flow chart of an embodied method for an automated manner for organizing digital records on a processor. The method begins by initiating a device with a processor (Step 200).

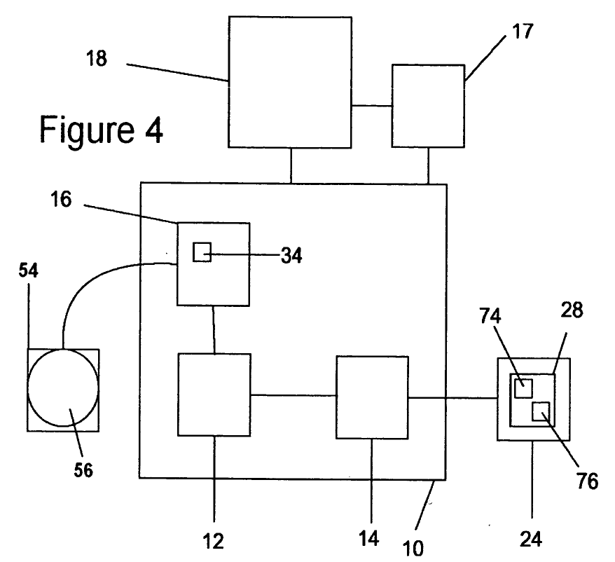

FIG. 4 depicts an alternative embodiment of a device usable with the method. The device has a processor 10. The processor 10 includes memory 12, an input port 14 connected to the memory 12, an output port 16 connected to the memory 12, an interactive input device 17 connected to the processor 10, and a display 18 connected to the processor 10 and the interactive input device 17. A digital device 24 is connected to the input port 14 by a user. The digital device 24 includes digital records 28 that are transferred to the processor 10. The digital records 28 include digital records metadata 76 and digital record content 74. Once the digital records 28 are downloaded to the processor 10 into memory 12 through the input port 14, associated metadata 34 is extracted from the digital records metadata 76 in the memory 16. The processor 10 is connected to a DVD and/or CD writer 54 via the output port 16 that forms written DVD and/or CD 56 from the created bit stream.

Returning to FIG. 3, the user is instructed to operationally associate a digital device 24 via a physical connection or a wireless interface to the input port 14 of the device (Step 210). Examples of digital devices 24 include a camera phone, a digital camera, a digital camcorder, a compact disc, a CD-ROM, a disk, a hard disk, an internet, a lap top, a PDA, a wireless device, and combinations of these. The user is typically instructed via the display 18. Digital records 28 stored on digital device 24 are downloaded to the processor 10 in the device (Step 220). The metadata 34 found in the digital records metadata 76 of the digital records 28 are extracted (Step 230). The digital records are sorted using image event grouping algorithms based on optional input parameters via interactive input device 17 and the extracted metadata (Step 235). The parameters can include a user's choice for type of sorting, such by date/time, by people, by location, by content similarity, or combination thereof. The digital records 28 are sorted into groups using an event grouping algorithm (Step 240). After the groups are formed, the groups are mapped to the template to create an index file corresponding to the groups (Step 250). The digital records 28 are updated (Step 260). The updated digital record and the index file are written to a DVD and/or CD writer 54, produced, and provided to the user (Step 270). The method can entail the optional step of printing a label with instructions or a title and affixing the label to the created DVD and/or CD 56 (Step 280).

Additional text, digital content, color or templates to frame images can be entered by the user using the interactive display device 17. The additional content can include information added at the beginning of at least one chapter, at the beginning of the entire DVD or CD, between chapters, or between digital records in the groups.

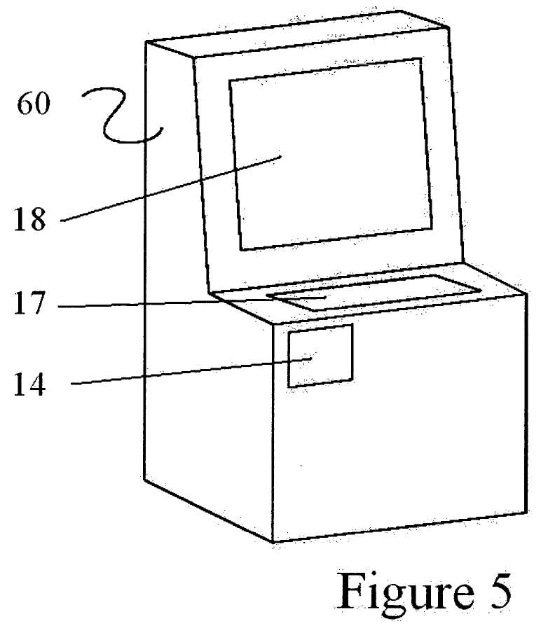

FIG. 5 depicts the device used in the embodied methods as self-serving kiosk 60.

Further, although the invention is described in terms of a user going to a kiosk, loading images via a wireless interface or a physical connection, and creating an image storage disk such as a DVD or CD, the present invention can also be practiced over the internet. That is, the kiosk, in accordance with the present invention, can be enabled with an internet connection to permit a user to load their images onto the kiosk from a remote location via the internet, and pick up their DVD or CD at a later time at the kiosk or behind the counter of a retail establishment. As a further option, a user can load the images at a first kiosk, send the images via the internet to a second kiosk that is located at a place that is more convenient for pick-up, and pick-up the DVD or CD at the location of the second kiosk.

The invention has been described in detail with particular reference to certain preferred embodiments thereof, but it will be understood that variations and modifications can be effected within the spirit and scope of the invention.

### PARTS LIST

10. processor
12. memory
14. input port
16. output port
17. interactive input device
18. display
24. digital device
28. digital record
34. extracted metadata
54. DVD writer
56. written DVD
58. custom label
60. kiosk
64. printer
74. digital record content
76. digital record metadata
100. step of initiating a processor
110. step of connecting a digital image capture device to the input port of the processor
120. step of downloading digital images from device to the processor
130. step of extracting metadata associated with the downloaded digital images
140. step of inputting sorting parameters manually
145. step of using an event grouping algorithm to sort
150. step of sorting the digital images into groups based on parameters and map to a template
160. step of saving template to memory as a bit stream containing chapters pertaining to groups
170. step of sending bit stream to writer, writing bit stream to a disc, and producing a DVD
180. step of printing label containing title or instructions
200. step of initiating a processor
210. step of connecting a digital image capture device to the input port
220. step of downloading digital images from device to the processor
230. step of extracting metadata associated with the downloaded digital images
235. step of inputting sorting parameters manually
240. step of using an event grouping algorithm to sort
250. step of mapping the groups to a template to create an index file
260. step of saving index file to memory and updating the digital records
270. step of sending updated digital records and index file to writer, writing updated digital records to a disc, and producing a DVD
280. step of printing label containing title or instructions

1. An automated method for creating an image storage device for playback on a playback mechanism, wherein the method comprises the steps:
a. initiating a processor comprising memory, an input port connected to the memory, an output port connected to the memory, an interactive input device operationally associate to the processor, and a display connected to the processor and the interactive input device;
b. providing a first instruction onto the display requesting a user to operationally associate a digital image capture device to the input port;
c. providing a second instruction via the input port to the digital image capture device requesting digital records to be downloaded to the processor, wherein the digital records comprise image metadata and image content;
d. downloading the digital records into the memory;
e. extracting metadata from the image metadata;
f. sorting the digital records based on parameters to form groups of digital records;
g. mapping the groups of digital records into a digital file template forming a digital file with chapters, wherein each group of digital records corresponds to a chapter;
h. creating a bit stream from the digital file with chapters, wherein the bit stream represents the chapters in a sequential order;
i. saving the bit stream to the memory;
j. sending the bit stream to a writer via the output port thereby forming a written image storage device; and
k. providing the written image storage device to the user.

2. The method of claim 1, wherein the parameters are established by default or acquired via the interactive input device to select event grouping algorithms.

3. The method of claim 1, wherein the image storage device is a disk.

4. The method of claim 3, further comprising a step of making a custom label for the written disk by entering text through the interactive input device and instructing the processor to provide a printing instruction to a printer connected to the processor to print the text onto the custom label.

5. The method of claim 3, further comprising a step of placing a preprinted label onto the written disk after the bit stream is written to the disk.

6. The method of claim 1, further comprising a step of adding an automatic transition between the groups of digital records.

7. The method of claim 1, further comprising a step of adding an automatic transition between digital images within a group.

8. The method of claim 3, further comprising a step of providing an additional instruction to the user to indicate a quantity of written disks to be produced and then using that indicated quantity to produce that quantity of written disks.

9. The method of claim 1, further comprising a step of instructing the user to insert additional text via the interactive input device and additional digital content via the input port, and combinations thereof to the memory prior to creating the bit stream.

10. The method of claim 9, wherein the additional text comprises chapter titles.

11. The method of claim 1, wherein the digital image capture device is selected the a group consisting of a camera phone, a digital camera, a

11. The method of claim 1, wherein the digital image capture device is selected the a group consisting of a camera phone, a digital camera, a digital camcorder, a compact disc, a CD-ROM, a disk, a hard disk, an internet, a lap top, a PDA, a wireless device, and combinations thereof.

12. The method of claim 1, further comprising a step of identifying each chapter by a chapter number after mapping is complete.

13. The method of claim 1, further comprising a step of further sorting the groups into subgroups based upon the image metadata and image content.

14. The method of claim 13, wherein the image metadata and image content comprise:
a. a date and time;
b. a location;
c. a content description;
d. a subject; and
e. combinations thereof.

15. The method of claim 1, wherein the interactive input device is a touch screen display, a mouse, a keyboard, a wand, or combinations thereof.

16. The method of claim 1, wherein the processor and display are in the form of a kiosk.

17. The method of claim 16, wherein the kiosk is a self-service kiosk.

18. The method of claim 1, where the image storage device is a DVD or CD.

19. The method of claim 13, wherein the image metadata and image content comprise information about people.

20. A customizable automated method for creating an image storage device for playback on a playback mechanism, wherein the method comprises the steps:
a. initiating a processor comprising memory, an input port connected to the memory, an output port connected to the memory, an interactive input device connected to the processor, and a display connected to the processor and the interactive input device;
b. providing a first instruction onto the display requesting a user to operationally associate a digital image capture device to the input port;
c. providing a second instruction via the input port to the digital image capture device requesting digital records to be downloaded to the processor, wherein the digital records comprise image metadata and image content;
d. downloading the digital records into the memory;
e. extracting metadata from the image metadata;
f. sorting the digital records based on parameters to form groups of digital records;
g. viewing and editing the groups of digital records, wherein the editing is done using the interactive input device;
h. mapping the groups of digital records into a digital file template forming a digital file with chapters, wherein each group of digital records corresponds to a chapter;
i. creating an customized digital file with chapters, wherein the customized digital file is created by the steps of:
i. selecting a theme for at least a portion of the image storage device based upon a theme list stored previously in the memory;
ii. selecting music for at least a portion of the image storage device based upon a music list stored previously in the memory;
iii. entering a title using a user interface and input the title to the digital file forming an first bit stream;
j. viewing the first bit stream;
k. creating a second bit stream from the first bit stream, wherein the second bit stream represents the chapters in a sequential order;
l. saving the bit stream to the memory;
m. sending the bit stream to an image storage device writer via the output port thereby forming a written image storage device; and
n. providing the written image storage device to the user.

21. The method of claim 20, wherein the parameters are established by default or acquired via the interactive input device to select event grouping algorithms.

22. The method of claim 20, wherein the written image storage device is a disk.

23. The method of claim 22, further comprising a step of making a custom label for the written disk by entering text through the interactive input device and instructing the processor to provide a printing instruction to a printer connected to the processor to print the text onto the custom label.

24. The method of claim 22, further comprising a step of placing a preprinted label onto the written disk after the bit stream is written to the disk.

25. The method of claim 20, further comprising a step of adding an automatic transition between the groups of digital records.

26. The method of claim 20, further comprising a step of adding an automatic transition between digital images within a group.

27. The method of claim 22, further comprising a step of providing an additional instruction to the user to indicate a quantity of written disks to be produced and then using that indicated quantity to produce that quantity of written disks.

28. The method of claim 20, further comprising a step of instructing the user to insert additional text via the interactive input device and additional digital content via the input port, and combinations thereof to the memory prior to creating the second bit stream.

29. The method of claim 28, wherein the additional text comprises chapter titles.

30. The method of claim 20, wherein the digital image capture device is selected from the group consisting of a camera phone, a digital camera, a digital camcorder, a compact disc, a CD-ROM, a disk, a hard disk, an internet, a lap top, a PDA, a wireless device, and combinations thereof.

31. The method of claim 30, wherein the text is a chapter title.

32. The method of claim 30, wherein the additional digital content is selected from the group consisting of text, music, images, symbols, icons, colors, other digital content and combinations thereof.

33. The method of claim 20, further comprising a step of identifying each chapter by a chapter number after mapping is complete.

34. The method of claim 20, further comprising a step of further sorting the groups into subgroups based upon the image metadata and image content.

35. The method of claim 34, wherein the image metadata and image content comprise at least one of:
a. a date and time;
b. a location;
c. a content description;
d. a subject; and
e. people information.

36. The method of claim 20, wherein the interactive input device is a touch screen display, a mouse, a keyboard, a wand, or combinations thereof.

37. The method of claim 20, wherein the processor and display are in the form of a kiosk.

38. The method of claim 37, wherein the kiosk is a self-service kiosk.

39. The method of claim 20, wherein the image storage device is a CD or DVD.

40. An automated method for organizing digital records on a processor, wherein the method comprises the steps:
a. initiating a processor comprising memory, an input port connected to the memory, an output port connected to the memory, an interactive input device connected to the processor, and a display connected to the processor and the interactive input device;
b. providing an instruction via the input port to the digital image capture device requesting digital records to be downloaded to the processor, wherein the digital records comprise image metadata and image content;
c. downloading the digital records into the memory;
d. extracting metadata from the digital records metadata in the memory;
e. sorting the digital records based on parameters to form groups of digital records, wherein the parameters are selected from the group consisting of by organization type by date/time, by subject, by location, by content similarity, and combinations thereof;
f. creating an index file of the groups of digital records;
g. updating the digital record metadata with event boundary information corresponding to the index file for each digital record, thereby creating updated digital records;
h. saving the updated digital records and the index file into the memory; and
i. writing the updated digital records and the index file to a DVD, a CD, a CD-ROM, or a disk.

41. The method of claim 40, wherein the parameters are established by default or acquired via the interactive input device to select event grouping algorithms.

42. The method of claim 40, further comprising a step of making a custom label for the written DVD, CD, CD-ROM or disk by entering text through the interactive input device and instructing the processor to provide a printing instruction to a printer connected to the processor to print the text onto the custom label.

43. The method of claim 40, further comprising a step of placing a preprinted label onto the written DVD, CD, CD-ROM or disk after the bit stream is written to the DVD.

44. The method of claim 40, further comprising a step of providing an additional instruction to the user to indicate a quantity of written DVDs, CDs, CD-ROMs or disks, to be produced and then using that indicated quantity to produce that quantity of written DVDs, CDs, CD-ROMs, or disks.

45. The method of claim 40, further comprising a step of instructing the user to insert additional text via the interactive input device and additional digital content via the input port, and combinations thereof.

46. The method of claim 40, wherein the digital image capture device is selected the a group consisting of a camera phone, a digital camera, a digital camcorder, a compact disc, a CD-ROM, a disk, a hard disk, an internet, a lap top, a PDA, a wireless device, and combinations thereof.

47. The method of claim 40, further comprising a step of further sorting the groups into subgroups based upon the image metadata and image content.

48. The method of claim 47, wherein the image metadata and image content comprise:
a. a date and time;
b. a location;
c. a content description;
d. a subject; and
e. combinations thereof.

49. The method of claim 40, wherein the interactive input device is a touch screen display, a mouse, a keyboard, a wand, or combinations thereof.

50. The method of claim 40, wherein the processor and display are in the form of a kiosk.

51. The method of claim 50, wherein the kiosk is a self-service kiosk.

52. The method of claim 47, wherein the image metadata and image content include people information.
